(19) United States
(12) Patent Application Publication
(10) Pub. No.: US 2019/0031470 A1
(43) Pub. Date: Jan. 31, 2019

(54) BRAKE TORQUE DETECTION FOR ELEVATOR BRAKE

(71) Applicant: Otis Elevator Company, Farmington, CT (US)

(72) Inventors: Shinichi Furuta, Chiba (JP); Takahiro Yamada, Narita (JP); Keiji Hashimoto, Sakura, Chiba (JP); SungGun Cho, Seoul (KR); Yaodong Chen, Shanghai (CN)

(21) Appl. No.: 16/045,170

(22) Filed: Jul. 25, 2018

(30) Foreign Application Priority Data
Jul. 27, 2017 (CN) 201710622431.5

(51) Int. Cl. B66B 5/00; B66B 1/30

(52) U.S. Cl. CPC B66B 5/0018; B66B 1/304

(57) ABSTRACT

The present invention relates to braking torque detection for an elevator brake and belongs to the technical field of elevators. A braking torque detection method for an elevator brake according to the present invention comprises the following steps: a drive motor outputting a first detection torque for a first brake torque inspection; the drive motor stopping output of the detection torque in intermittent time periods when it is determined that a second brake torque inspection is required according to a result of the first brake torque inspection; and the drive motor outputting a second detection torque for the second brake torque inspection. The present invention can avoid overheating of a frequency converter in a continuous braking torque detection process and achieves good braking torque detection accuracy.

### FOREIGN PRIORITY

This application claims priority to Chinese Patent Application No. 201710622431.5, filed Jul. 27, 2017, and all the benefits accruing therefrom under 35 U.S.C. § 119, the contents of which in its entirety are herein incorporated by reference.

### TECHNICAL FIELD

The present invention relates to the technical field of elevators and relates to a braking torque detection method for an elevator brake and a braking torque detection system therefor.

### BACKGROUND ART

In an elevator system, in order to control traveling of an elevator car in a hoistway, a drive device and a brake device, that is, a drive motor (also referred to as a “hoisting motor” or a “hoisting electric motor”) and an elevator brake, are generally included, wherein the drive motor drives a traction wheel to rotate so that the elevator car travels in the hoistway, and the elevator brake performs a brake operation to enable the elevator car to stop or remain stationary. Therefore, the elevator brake is an important safety protection device in the elevator system and is also the most frequently used safety protection device, and the reliability of its operation directly affects the safety performance of the elevator system.

In order to ensure the operational safety of each elevator system, corresponding industry standards have been introduced for braking detection for elevator brakes, thereby enabling discovery of braking safety hazards or failures of the elevator brakes, and even understanding of dynamic changes of braking performances of the elevator brakes. Thus, braking detection for the elevator brakes is necessary or even strictly required.

### SUMMARY OF THE INVENTION

One object of the present invention is to improve the accuracy of braking detection for an elevator brake.

Another object of the present invention is to avoid overheating of a frequency converter that provides torque currents for a drive motor in a continuous braking detection process.

In order to achieve the above or other objects, the present invention provides the following technical solutions.

According to one aspect of the present invention, a braking torque detection method for an elevator brake is provided, wherein a frequency converter controls a drive motor to output a first detection torque and/or a second detection torque larger than the nominal load of an elevator car when the elevator brake is in a brake state; the braking torque detection method comprises the following steps: the drive motor outputting the first detection torque for a first brake torque inspection; the drive motor stopping output of the detection torque in intermittent time periods when it is determined that a second brake torque inspection is required according to a result of the first brake torque inspection; and the drive motor outputting the second detection torque for the second brake torque inspection.

According to a further aspect of the present invention, a braking torque detection system for an elevator brake is provided, comprising: a frequency converter used for controlling torque output of a drive motor; and a controller used for controlling the frequency converter and the elevator brake to enable the drive motor to output a first detection torque and/or a second detection torque larger than the nominal load of an elevator car when the elevator brake is in a brake state in a braking torque detection process; wherein the controller is configured to control at least the frequency converter and the elevator brake to perform the following steps: the drive motor outputting the first detection torque for a first brake torque inspection; the drive motor stopping output of the detection torque in intermittent time periods when it is determined that a second brake torque inspection is required according to a result of the first brake torque inspection; and the drive motor outputting the second detection torque for the second brake torque inspection.

According to a still further aspect of the present invention, a controller is provided for controlling a frequency converter and an elevator brake, comprising a memory, a processor, and computer programs stored on the memory and operable on the processor, wherein the processor implements the steps in the above braking torque detection method when performing the programs.

The above features and operations of the present invention will become more apparent through the below description and drawings.

### DESCRIPTION OF THE DRAWINGS

The above and other objects and advantages of the present invention will be more complete and clearer from the detailed description in conjunction with the accompanying drawings, wherein the same reference numbers are used to indicate the same or similar elements.

FIG. 1 is a schematic structural view of a braking torque detection system for an elevator brake according to an embodiment of the present invention.

FIG. 2 is a schematic flow chart of a braking torque detection method for an elevator brake according to an embodiment of the present invention.

FIG. 3 is a schematic view of output of a detection torque T1 and a detection torque T2 that are used in the braking torque detection method according to the embodiment as shown in FIG. 2.

FIG. 4 is a schematic flow chart of a braking torque detection method for an elevator brake according to a further embodiment of the present invention.

FIG. 5 is a schematic view of output of a detection torque T2 and a detection torque T1 that are used in the braking torque detection method according to the embodiment as shown in FIG. 4.

### DETAILED DESCRIPTION

Some of various possible embodiments of the present invention will be described below, which are intended to provide a basic understanding of the present invention and are not intended to identify key or critical elements of the present invention or to delineate the scope of the present invention. It will be readily appreciated that, in accordance with the technical solutions of the present invention, those of ordinary skill in the art may suggest other interchangeable implementation manners without departing from the spirit of the present invention. Therefore, the following detailed description and the accompanying drawings are merely illustrative of the technical solutions of the present invention and should not be considered as a whole of the present invention or as a limitation or restriction of the technical solutions of the present invention.

The present invention will now be described more fully with reference to the accompanying drawings, in which exemplary embodiments of the present invention are illustrated. However, the present invention can be implemented in many different forms and should not be limited to the embodiments described herein. Instead, these embodiments are provided so that this disclosure will be thorough and complete, and will fully convey the concept of the present invention to those skilled in the art. In the drawings, the same reference numerals denote the same elements or components, and thus description thereof will be omitted.

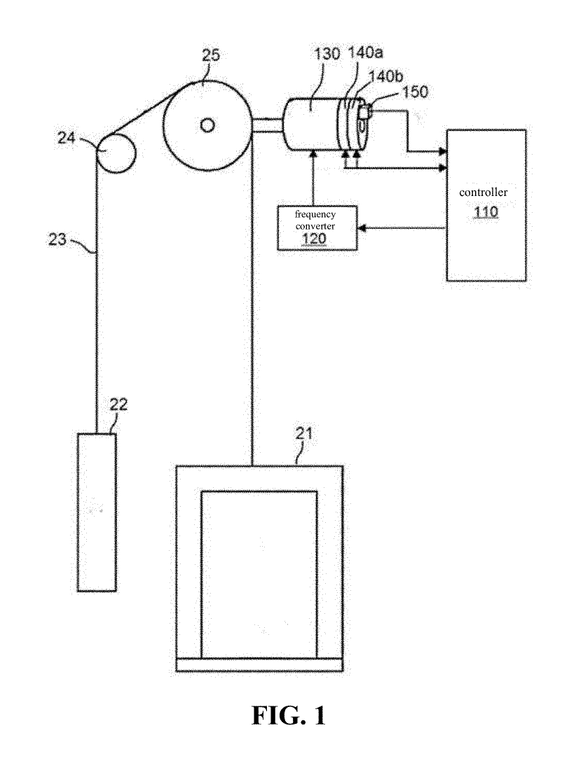

FIG. 1 is a schematic structural view of a braking torque detection system for an elevator brake according to an embodiment of the present invention. As shown in FIG. 1, an elevator system corresponding to the braking torque detection system includes an elevator car 21, a counterweight 22, a traction member 23 (for example, a rope), one or more steering wheels 24, and a traction wheel 25 (otherwise referred to as a sheave). FIG. 1 schematically illustrates only basic configurations or arrangements thereof, and it should be understood that the configurations or arrangements thereof are not limiting. For example, there may be a number of steering wheels 24, or winding methods of the traction wheel 25 and the traction member 23 can vary as well, even an arrangement without a counterweight can be realized.

The drive motor 130 provides torque output to drive the traction wheel 25 to rotate, thereby lifting the elevator car 21 to travel in the hoistway. In the elevator system, a nominal load is generally set for the elevator car 21. During braking, an elevator brake 140 of the elevator system (for example, using a double-brake structure including elevator brakes 140a and 140b) is in a brake state (i.e., a closed state), and the drive motor 130 stops outputting the torque, so as to stop rotation of the traction sheave 25 and traveling of the elevator car 21, that is, the brake operation is realized.

The braking torque detection system according to the embodiment of the present invention is provided with a frequency converter 120 for controlling torque currents supplied to the drive motor 130, thereby controlling the direction and magnitude of torque output of the drive motor 130, and a controller 110 that may be used for controlling the frequency converter 120 and the elevator brakes 140a and 140b. The braking torque detection system according to an embodiment of the present invention is further provided with an encoder 150, such that if the drive motor 130 rotates in the brake state, a sensing operation can be performed by the encoder 150 and a sensing result is fed back to the controller 110.

The braking torque detection system according to the embodiment of the present invention has a self-detection function. In order to realize self-detection, when the elevator brake 140 is in the brake state, the frequency converter 120 controls the drive motor 130 to output a detection torque larger than the nominal load of the elevator car. The nominal load of the elevator car is a weight corresponding to the nominal capacity of the elevator car (for example, 1000 Kg, 13 persons), which can be set in advance when the elevator system is shipped. The magnitude of the detection torque is known and can be set in advance. When the drive motor 130 outputs the detection torque, the elevator brake 140 maintains the brake state. If the drive motor 130 cannot be stopped, it is detected by the encoder 150 that the drive motor 130 rotates in the brake state, that is, it can be known that there is insufficient brake torque in the elevator brake 140, thereby achieving Brake Torque Inspection (BTI). The above automatic BTI process is automatically implemented through control of the controller 110 of the braking torque detection system.

Therefore, in the braking torque detection process, the detection torque output by the drive motor 130 is implemented through control of the frequency converter 120 according to preset detection torque, and whether the drive motor 130 can accurately output the preset detection torque will directly affect the accuracy of the BTI, that is, it will affect the accuracy of the braking detection.

A Chinese Patent Application No. 200810037218.9, entitled “A METHOD FOR REALIZING MOTOR BRAKE TORQUE DETECTION”, discloses a braking torque detection method for an elevator brake. In a braking torque detection process, when the elevator brake is in a brake state, a drive motor (i.e., an electric motor) continuously outputs two types of detection torque, that is, two levels of a severely insufficient standard torque value and a slightly insufficient standard torque value. If the elevator slips during output of the severely insufficient standard torque value, it is judged as a first-level failure that the brake torque is severely insufficient, and if the elevator slips during output of the slightly insufficient standard torque value, it is judged as a second-level failure that the brake torque is slightly insufficient.

However, the applicant has found that, in the actual braking torque detection process, since the two levels of detection torque are both large and are continuously output, the frequency converter that continuously supplies large torque currents is prone to overheating in the braking torque detection process disclosed in the above patent. For example, because IGBT devices inside the frequency converter are working under high power conditions and are prone to overheating, on one hand, the frequency converter itself may be susceptible to failure or damage, on the other hand, the torque currents output by the frequency converter are easily caused to be not exactly equal to a preset value, so that the accuracy of the detection torque output by the drive motor is reduced (especially in a later stage of detection), which significantly affects the accuracy of the BTI result.

In the braking torque detection system according to the embodiment of the present invention, the frequency converter 120 is controlled by the controller 110, so that the drive motor 130 is controlled to respectively output two levels of detection torque, i.e., the detection torque T1 and the detection torque T2. There are intermittent time periods between the output of the detection torque T1 and the output of the detection torque T2, and output of detection torque is stopped in the intermittent time periods.

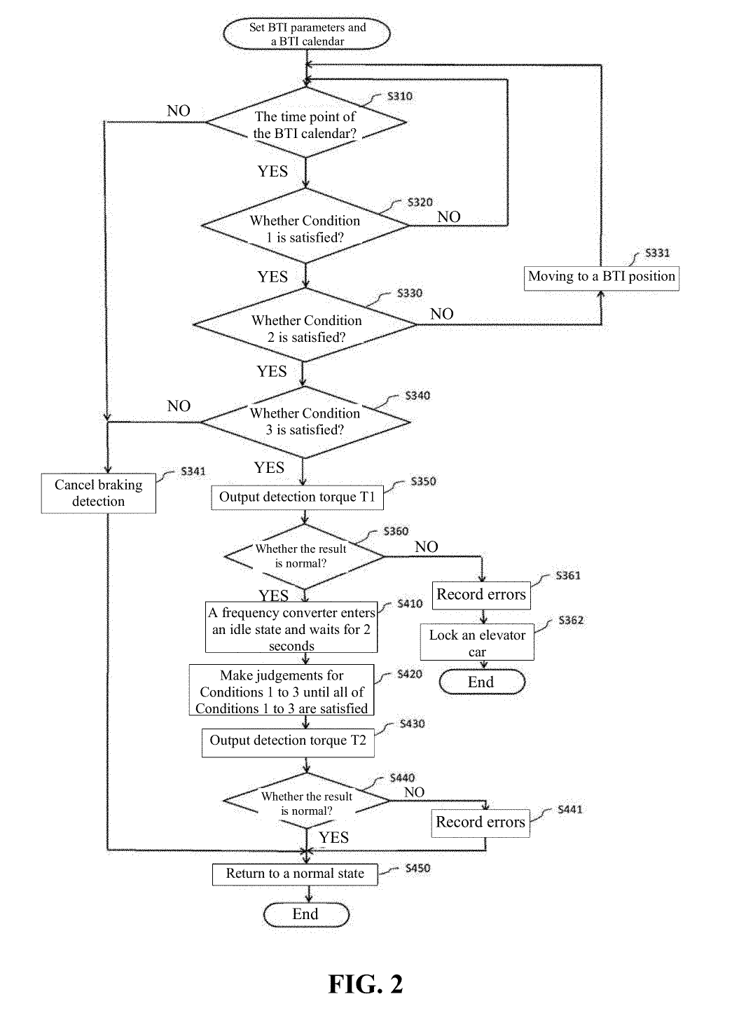

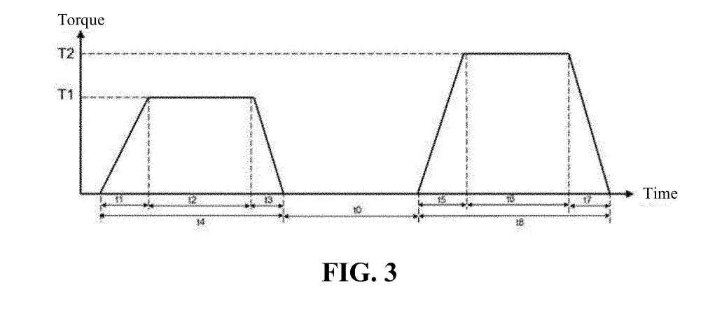

FIG. 2 is a schematic flow chart of a braking torque detection method for an elevator brake according to an embodiment of the present invention; and FIG. 3 is a schematic view of output of the detection torque T1 and the detection torque T2 that are used in the braking torque detection method according to the embodiment as shown in FIG. 2. The braking torque detection method for an elevator brake according to the embodiment will be exemplarily illustrated below in conjunction with FIG. 2 and FIG. 3.

First, a braking torque detection calendar, for example, a BTI calendar, is preset to determine a trigger time point for each brake torque detection. For example, the trigger time point is set according to a predetermined cycle (daily, weekly, or monthly), so as to form a calendar through editing, and the braking torque detection system can be automatically triggered to work at the set cycle time through the calendar. Therefore, the BTI calendar reflects the time point at which the braking torque detection needs to be performed, and also reflects the cycle of braking torque detection. It will be understood that the trigger time point may be a time period range, for example, a time period range of a half hour or one hour, during which judgements for start conditions in steps S320-S340 may be repeatedly made until Conditions 1 to 3 are satisfied. The braking torque detection cycle may also vary depending on the operating condition of the elevator system. Meanwhile, it is also necessary to set BTI parameters in advance, the BTI parameters including, for example, the detection torque T1, the detection torque T2, lengths of the intermittent time periods, and the like. The BTI parameters may be defined as desired according to user demands to specifically define the braking torque detection process.

The BTI parameters and the brake torque detection calendar may be stored in the controller 110 and the frequency converter 120. The controller 110 judges whether the current time is the time point of the BTI calendar, i.e., step S310. If the judgement is “NO”, the braking torque detection is canceled, that is, the process proceeds to step S341, and if the judgement is “YES”, the BTI start condition judgement is performed next.

In step S320, it is judged whether Condition 1 is satisfied, and Condition 1 is specifically that the elevator car 21 is in an idle state and parameters (i.e., the BTI parameters) set for the brake torque inspection are valid. In the idle state, the elevator car 21 is stationary and located at a landing, the load is less than, for example, 80 kg, a car door is closed, lights inside the car are off, and neither landing calls to the elevator car 21 or calls from the elevator car 21 exist (that is, no destination floor command is registered inside the elevator car). Performing the braking torque detection in the idle state will not affect normal operations of the elevator.

If the judgement is “NO”, the process returns to step S310. If the judgement is “YES”, the process proceeds to step S330, that is, it is judged whether Condition 2 is satisfied. Condition 2 is specifically that the elevator car stops at a predetermined brake torque inspection position, i.e., a BTI position. The BTI position is optionally the top floor position of the hoistway, such that the occurrence of a ceiling-hit or bottom-hit event due to failure in the braking torque detection process can be prevented.

If the judgement is “NO”, the elevator car 21 is driven to move to the BTI position (step S331), and then the process returns to step S310. If the judgement is “YES”, the process proceeds to step S340 to judge whether Condition 3 is satisfied. Condition 3 is specifically that there is no unprocessed elevator brake-related failure record in an elevator controller. For example, the controller 110 detects whether there is an unprocessed failure record, such as slipping during brake and the like, corresponding to the elevator brake 140 in the elevator controller. If the judgement is “NO”, the process proceeds to step S341; and if the judgement is “YES”, the process proceeds to step S350.

In step S350, the drive motor 130 outputs the detection torque T1 for a first brake torque inspection. In this step, the controller 110 controls the frequency converter 120 to output corresponding torque currents, thus the drive motor 130 outputs the detection torque T1. At this time, the controller 110 has already controlled the elevator brake 140 to be in the brake state.

In an embodiment, the magnitude of the detection torque T1 is substantially equal to 125% of the nominal load of the elevator car. The specific magnitude of the detection torque T1 is not limited to 125% of the nominal load of the elevator car and may be set around 125% of the nominal load, for example.

In an embodiment, as shown in FIG. 3, during a time period t1, the frequency converter 120 controls the output torque of the drive motor 130 to rapidly increase to the detection torque T1. During a time period t2, the frequency converter 120 controls the output torque of drive motor 130 to remain substantially constant at the detection torque T1. After the first BTI is completed, the frequency converter 120 controls the output torque of the drive motor 130 to rapidly drop to 0 during a time period t3. t1, t2, and t3 may be determined according to BTI parameter settings, for example, t2=3 seconds. The time during which the drive motor 130 outputs the detection torque T1 is t4 as a whole, which is equal to the sum of t1, t2, and t3.

In the first brake torque inspection process, it is judged whether the result is normal, i.e., step S360, and if normal, it is indicated that a failure that the brake torque is severely insufficient does not exist in the elevator brake 140. For example, the brake torque provided by the elevator brake 140 can effectively brake the operating elevator car 21 running under normal conditions. If it is judged that the result is abnormal, it is indicated that the brake torque provided by the elevator brake 140 is severely insufficient, which may be caused by worn brake pads or other reasons, and safety hazards or safety problems exist during traveling of the elevator. At this time, errors are recorded, i.e., step S361, and the elevator car is locked, i.e., step S362.

If the judgement is “YES” in step S360, the process proceeds to step S410, and the frequency converter 120 is enabled to enter an idle waiting state and wait for 1-20 seconds (for example, 2 seconds). The frequency converter 120 will not supply the torque currents at least within the 1-20 seconds, that is, the drive motor 130 stops outputting the detection torque within the 2 seconds. At this time, a power device (such as an IGBT, and the like) inside the frequency converter 120 stops working, and heat generation is rapidly reduced, and not only does the temperature rise of the frequency converter 120 stop (due to output of a large torque current for the first BTI), but also a good temperature drop effect is achieved, thereby greatly improving subsequent working conditions for the power device of the frequency converter 120.

Further, the process proceeds to step S420, and the judgements for Conditions 1 to 3 are made until all of Conditions 1 to 3 are satisfied, that is, before a second detection torque is output, a second judgement for the BTI start condition is made in the intermittent time periods. The above judgement processes of the Conditions 1 to 3 are the same as those of step S320 to step S340, and detailed description is omitted herein.

Further, the process proceeds to step S430, the drive motor 130 outputs the detection torque T2 for the second brake torque inspection. In this step, the controller 110 controls the frequency converter 120 to output corresponding torque currents, thus the drive motor 130 outputs the detection torque T2. At this time, the controller 110 has already controlled the elevator brake 140 to be in the brake state.

In an embodiment, the magnitude of the detection torque T2 is substantially equal to 140%-160% of the nominal load of the elevator car, specifically equal to 150% of the nominal load of the elevator car, for example. The specific magnitude of the detection torque T2 is not limited to 150% of the nominal load of the elevator car and may be selectively set in the range of 140% to 160% of the nominal load, for example.

In an embodiment, as shown in FIG. 3, during a time period t5, the frequency converter 120 controls the output torque of the drive motor 130 to rapidly increase to the detection torque T2. During a time period t6, the frequency converter 120 controls the output torque of drive motor 130 to remain substantially constant at the detection torque T2. After the second BTI is completed, the frequency converter 120 controls the output torque of the drive motor 130 to rapidly drop to 0 during a time period t7. t5, t6, and t7 may be determined according to the BTI parameter settings, for example, t6=3 seconds. The time during which the drive motor 130 outputs the detection torque T2 is t8 as a whole, which is equal to the sum of t5, t6, and t7.

Meanwhile, it should be noted that when the frequency converter 120 controls two times of torque output of the drive motor 130, an intermittent time period t0 as shown in FIG. 3 is correspondingly formed, and both steps S410 and S420 of the embodiment of the present invention occur during the intermittent time period t0. Thus, even if the detection torque T2 of the second BTI is larger, since the frequency converter 120 is ready to be cooled down in the intermittent time period t0, the heat generation problem of the frequency converter 120 will be greatly alleviated during the time period t8, which is advantageous for ensuring the operational reliability of the frequency converter 120, and simultaneously also facilitates supplying of accurate torque currents by the frequency converter 120, so that the drive motor 130 is capable of outputting an accurate detection torque T2 in accordance with a predetermined value.

Further, in the second brake torque inspection process, it is judged whether the result is normal, i.e., step S440, and if normal, it is indicated that the elevator brake 140 is normal. For example, the brake torque provided by the elevator brake 140 in the brake state is sufficient. The process proceeds to step S450, the elevator returns to a normal traveling state, and the braking torque detection for the elevator brake 140 is completed. If it is judged that the result is abnormal, it is indicated that the brake torque provided by the elevator brake 140 may be slightly insufficient. At this time, errors are recorded, i.e., step S441. However, operations of the elevator system are not suspended, and the process also proceeds to step S450.

In the braking torque detection processes of the above embodiments, there are two BTI processes, and the two BTI processes are relatively independent. There are intermittent time periods in the middle to avoid overheating of the frequency converter 120 due to continuous supplying of large torque currents for a long time. The reliability of the frequency converter can be guaranteed, and the detection for the brake torque is more accurate, that is, the braking torque detection for the elevator brake is more accurate. Moreover, the judgements for Conditions 1 to 3 are also made for the second BTI (i.e., step S420), so that the detection accuracy of the second BTI can be ensured.

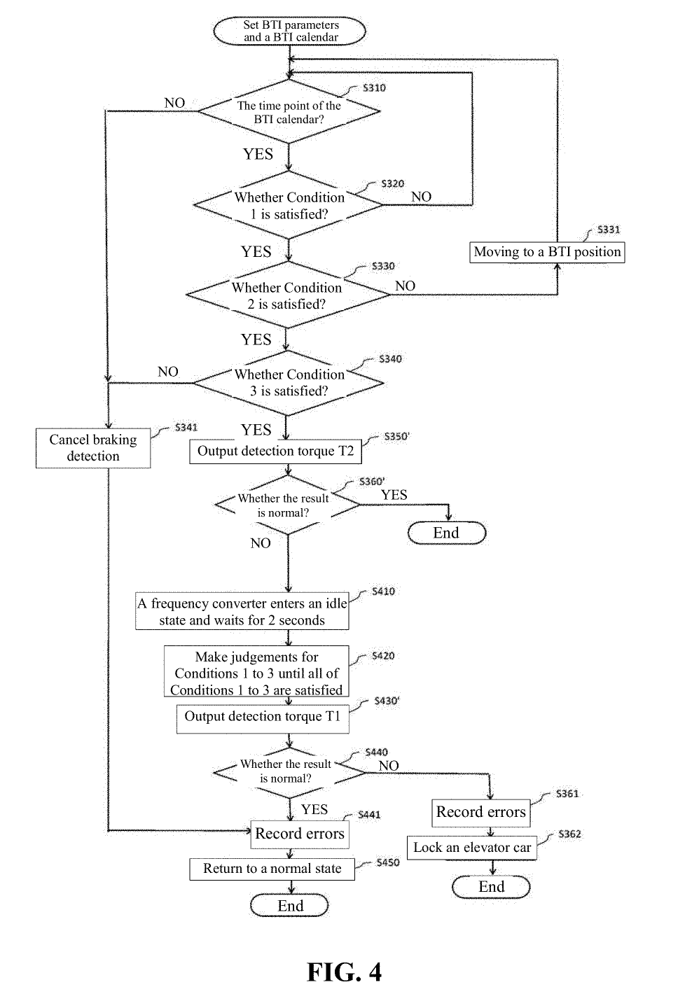

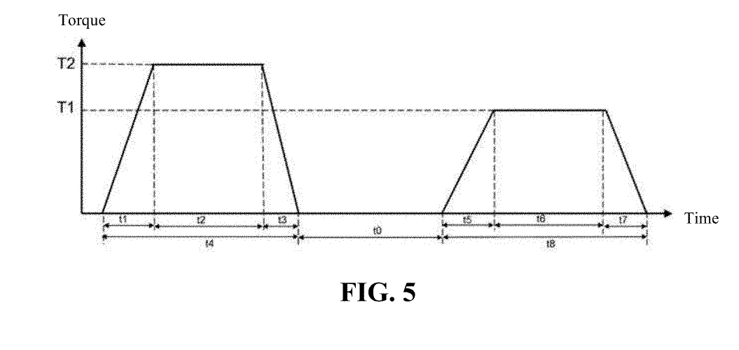

FIG. 4 is a schematic flow chart of a braking torque detection method for an elevator brake according to a further embodiment of the present invention; and FIG. 5 is a schematic view of output of a detection torque T2 and a detection torque T1 that are used in the braking torque detection method according to the embodiment as shown in FIG. 6. The braking torque detection method for an elevator brake according to the embodiment will be exemplarily illustrated below in conjunction with FIG. 3 and FIG. 5.

Compared with the braking torque detection method according to the embodiment shown in FIG. 2, the braking torque detection method of the embodiment shown in FIG. 4 also includes two times of BTI, but the main difference is that the detection torque output by the drive motor 130 in the first BTI is larger than the detection torque output by the drive motor 130 in the second BTI, that is, in the braking torque detection method of the embodiment shown in FIG. 4, the larger detection torque T2 is firstly output for detection, and then the smaller detection torque T1 is output for detection in an abnormal case. Of course, both the detection torque T2 and the detection torque T1 are larger than the nominal load of the elevator car.

Specifically, in the steps of the braking torque detection method of the embodiment shown in FIG. 4, in step S350′, the drive motor 130 outputs the detection torque T2 for the first brake torque inspection. In this step, the controller 110 controls the frequency converter 120 to output corresponding torque currents, thus the drive motor 130 outputs the detection torque T2. At this time, the controller 110 has already controlled the elevator brake 140 to be in the brake state.

In an embodiment, the magnitude of the detection torque T2 is substantially equal to 140%-160% of the nominal load of the elevator car, specifically equal to 150% of the nominal load of the elevator car, for example. The specific magnitude of the detection torque T2 is not limited to 150% of the nominal load of the elevator car and may be selectively set in the range of 140% to 160% of the nominal load, for example.

In an embodiment, as shown in FIG. 5, during the time period t1, the frequency converter 120 controls the output torque of the drive motor 130 to rapidly increase to the detection torque T2. During the time period t2, the frequency converter 120 controls the output torque of drive motor 130 to remain substantially constant at the detection torque T2. After the second BTI is completed, the frequency converter 120 controls the output torque of the drive motor 130 to rapidly drop to 0 during the time period t3. t5, t6, and t7 may be determined according to the BTI parameter settings, for example, t3=3 seconds. The time during which the drive motor 130 outputs the detection torque T2 is t4 as a whole, which is equal to the sum of t1, t2, and t3.

In the first brake torque inspection process, it is judged whether the result is normal, i.e., step S360′, and if normal, it is indicated that a failure that the brake torque is insufficient does not exist in the elevator brake 140, and the process of the braking torque detection method ends; and if abnormal, the process proceeds to steps S410 and S420.

In step 430′, the drive motor 130 outputs the detection torque T1 for the second brake torque inspection. In this step, the controller 110 controls the frequency converter 120 to output corresponding torque currents, thus the drive motor 130 outputs the detection torque T1. At this time, the controller 110 has already controlled the elevator brake 140 to be in the brake state.

In an embodiment, the magnitude of the detection torque T1 is substantially equal to 125% of the nominal load of the elevator car. The specific magnitude of the detection torque T1 is not limited to 125% of the nominal load of the elevator car and may be set around 125% of the nominal load, for example.

In an embodiment, as shown in FIG. 3, during the time period t5, the frequency converter 120 controls the output torque of the drive motor 130 to rapidly increase to the detection torque T1. During the time period t6, the frequency converter 120 controls the output torque of drive motor 130 to remain substantially constant at the detection torque T1. After the first BTI is completed, the frequency converter 120 controls the output torque of the drive motor 130 to rapidly drop to 0 during the time period t7. t5, t6, and t7 may be determined according to the BTI parameter settings, for example, t6=3 seconds. The time during which the drive motor 130 outputs the detection torque T1 is t8 as a whole, which is equal to the sum of t5, t6, and t7.

In the second brake torque inspection process, it is judged whether the result is normal, i.e., step S440, and if normal, it is indicated that a failure that the brake torque is severely insufficient does not exist in the elevator brake 140, but a failure that the brake torque is slightly insufficient exists. The process proceeds to step S441, and corresponding errors are recorded. If it is judged that the result is abnormal, it is indicated that the brake torque provided by the elevator brake 140 is severely insufficient, which may be caused by worn brake pads or other reasons, and safety hazards or safety problems exist during traveling of the elevator. At this time, errors are recorded, i.e., step S361, and the elevator car is locked, i.e., step S362. The process of the braking torque detection method ends.

Other method steps in the embodiment shown in FIG. 4 that are the same as those in the embodiment shown in FIG. 1 are not repeatedly described herein. It should be understood that, compared with the braking torque detection method of the embodiment shown in FIG. 2, the braking torque detection method of the embodiment shown in FIG. 4 has substantially the same technical effect since it also has the intermittent time periods corresponding to steps S410 and S420. However, in practical applications of the braking torque detection method shown in FIG. 4, the judgement is “YES” in step S360′ in many cases, and therefore a situation in which the frequency converter is overheated is relatively rare.

The method steps of the embodiments shown in FIG. 2 and FIG. 4 above may be implemented by the controller 110. The controller 110 may specifically be a processor of various programmable settings, etc., and the specific types thereof are not limiting. For example, the controller 110 comprises a memory, a processor, and computer programs stored on the memory and operable on the processor, wherein the processor implements the steps in the methods according to the embodiment as shown in FIG. 2 when performing the programs.

As will be appreciated by those skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “service”, “circuit”, “circuit system”, “module” or “processing system”. Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but is not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object-oriented programming language such as Java, Smalltalk, C++ or the like and conventional procedural programming languages, such as the “C” programming language or similar programming languages. The program code may execute entirely on the user's computer (device), partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The computer program instructions may be provided to a processor of a general-purpose computer, special purpose computer, such as an image processor or other programmable data processing apparatus to produce a machine, such that the instructions, which execute via the processor of the computer or other programmable data processing apparatus, create means for implementing the functions/acts specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions and acts specified herein.

It should also be noted that, in some alternative implementation manners, the functions/operations noted in the block may occur out of the order noted in the flowchart. For example, two blocks shown in succession may, in fact, be executed substantially concurrently, or the blocks may sometimes be executed in the reverse order, depending upon the functionality/operation involved. Although a particular order of steps is shown, disclosed, and claimed, it should be understood that the steps can be carried out, separated or combined in any order, unless otherwise indicated, and will still benefit from the disclosure.

The description uses examples to disclose the invention, including the best mode, and also to enable any person skilled in the art to practice the invention, including making and using any devices or systems and performing any incorporated methods. The patent protection scope of the present invention is defined by the claims, and may include other examples that are contemplated by those skilled in the art. Such examples are intended to be within the scope of the claims if they have structural elements that do not differ from the literal language of the claims, or if they include equivalent structural elements with insubstantial differences from the literal languages of the claims.

1. A braking torque detection method for an elevator brake, a frequency converter controlling a drive motor to output a first detection torque and/or a second detection torque larger than the nominal load of an elevator car when the elevator brake is in a brake state, characterized in that the braking torque detection method comprises the following steps:
the drive motor outputting the first detection torque for a first brake torque inspection;
the drive motor stopping output of the detection torque in intermittent time periods when it is determined that a second brake torque inspection is required according to a result of the first brake torque inspection; and
the drive motor outputting the second detection torque for the second brake torque inspection.

2. The braking torque detection method according to claim 1, characterized in that the second detection torque is larger than the first detection torque, wherein it is determined that the second brake torque detection is required when the first brake torque detection result is normal.

3. The braking torque detection method according to claim 1, characterized in that the second detection torque is smaller than the first detection torque, wherein it is determined that the second brake torque detection is required when the first brake torque detection result is abnormal.

4. The braking torque detection method according to claim 1, characterized in that a first judgement for brake torque inspection start conditions is made before the first detection torque is output, and the first detection torque is output only if the brake torque inspection start conditions are satisfied.

5. The braking torque detection method according to claim 1, characterized in that a second judgement for the brake torque inspection start conditions is made in the intermittent time periods before the second detection torque is output, and the second detection torque is output only if the brake torque inspection start conditions are satisfied.

6. The braking torque detection method according to claim 5, characterized in that the second judgement for the brake torque inspection start conditions is made after waiting for 1 to 20 seconds in the intermittent time periods.

7. The braking torque detection method according to claim 4, characterized in that the brake torque inspection start conditions comprise:
Condition 1: the elevator car being in an idle state and parameters set for the brake torque inspection being valid;
Condition 2: the elevator car stopping at a predetermined brake torque inspection position; and
Condition 3: no unprocessed elevator brake-related failure record existing in an elevator controller.

8. The braking torque detection method according to claim 7, characterized in that if Condition 2 is not satisfied, the elevator car is driven to travel to a brake torque inspection position.

9. The braking torque detection method according to claim 7, characterized in that the brake torque inspection position is the top floor position.

10. The braking torque detection method according to claim 2, characterized in that the magnitude of the first detection torque is equal to about 125% of the nominal load of the elevator car, and the magnitude of the second detection torque ranges from 140% to 160% of the nominal load of the elevator car.

11. The braking torque detection method according to claim 10, characterized in that the magnitude of the second detection torque is equal to about 150% of the nominal load of the elevator car.

12. The braking torque detection method according to claim 3, characterized in that the magnitude of the second detection torque is equal to about 125% of the nominal load of the elevator car, and the magnitude of the first detection torque ranges from 140% to 160% of the nominal load of the elevator car.

13. The braking torque detection method according to claim 10, characterized in that the magnitude of the first detection torque is equal to about 150% of the nominal load of the elevator car.

14. The braking torque detection method according to claim 2, characterized in that the elevator car is locked and the braking detection is ended when the first brake torque inspection result is abnormal.

15. The braking torque detection method according to claim 2, characterized in that the braking torque detection method is ended when the first brake torque inspection result is normal.

16. The braking torque detection method according to claim 1, characterized in that the braking torque detection method is automatically triggered in accordance with a preset calendar for the braking torque detection.

17. The braking torque detection method according to claim 2, characterized in that errors are recorded and the elevator car is locked when the first brake torque inspection result is abnormal, and errors are recorded and the elevator system returns to a normal state when the second brake torque inspection result is abnormal.

18. A braking torque detection system for an elevator brake, comprising:
a frequency converter used for controlling torque output of a drive motor; and
a controller used for controlling the frequency converter and the elevator brake to enable the drive motor to output a first detection torque and/or a second detection torque larger than the nominal load of an elevator car when the elevator brake is in a brake state in a braking torque detection process;
characterized in that the controller is configured to control at least the frequency converter and the elevator brake to perform the following steps:
the drive motor outputting the first detection torque for a first brake torque inspection;
the drive motor stopping output of the detection torque in intermittent time periods when it is determined that a second brake torque inspection is required according to a result of the first brake torque inspection; and
the drive motor outputting the second detection torque for the second brake torque inspection.

19. (canceled)

20. A controller used for controlling a frequency converter and an elevator brake, comprising a memory, a processor, and computer programs stored on the memory and operable on the processor, characterized in that the processor implements the steps in the methods according to claim 1 when performing the programs.
